(19) United States
(12) Patent Application Publication
(10) Pub. No.: US 2012/0093205 A1
(43) Pub. Date: Apr. 19, 2012

(54) ELECTRONIC DEVICE WITH REMOVABLE ACCESSORY

(75) Inventors: Henri CROHAS, VERRIERES-LE-BUISSON (FR); Yves GREGOIRE, CHATENAY MALABRY (FR)

(73) Assignee: ARCHOS, IGNY (FR)

(21) Appl. No.: 13/107,340

(22) Filed: May 13, 2011

(30) Foreign Application Priority Data
Oct. 18, 2010 (FR) 10 58463

(51) Int. Cl. H04B 1/38

(52) U.S. Cl. 375/222

(57) ABSTRACT

An electronic device is arranged to receive a removable wireless remote data transmission accessory, in particular of the 3G “stick modem” or Wifi type, the accessory including an accessory body, at least one radio antenna, an accessory connection element linked to the accessory body, the device including a device connection element, arranged to connect with the removable accessory and to be coupled with the accessory connection element, characterized in that the device is arranged to receive the removable accessory in a slot, the device being structured so as to allow the radio antenna to transmit data remotely when the accessory body and/or the radio antenna is at least partially inserted in the slot, in an active data transmission position of the accessory. The invention relates in particular to devices receiving removable accessories of the “3G modem” or “Wifi” type.

### TECHNICAL FIELD

The present invention relates to an electronic device arranged to receive an accessory, said accessory allowing remote wireless data transmission.

The invention relates in particular to compact and portable electronic devices.

### STATE OF THE ART

Electronic devices are known of the mobile phone, multimedia player or tablet type receiving a removable accessory allowing remote wireless data transmission (3G, Edge, Bluetooth and other wireless standards). Accessories of this type are for example 3G modem sticks or 3G modem cards. Their connection means correspond to various norms or standards: USB, PCMCIA, HDMI, SD, MICRO SD, Firewire etc. or equivalents. It is convenient to be able to remove or separate such an accessory from the device in order to transport data or transfer data from one device to another. This distinguishes such accessories from a means of wireless transmission that is fully integrated into a device such as a Wifi modem that cannot be removed.

When the accessory is in the form of a card, the latter generally is very small in size, making its handling awkward, in particular when it must be installed in an external slot of the device or removed therefrom and there is also a risk of loss. Moreover, not all devices include a slot suitable for such cards, thereby restricting the versatility and the benefit of this type of card.

Other known accessories adopt the form of a stick, having an outer body that is easy to handle and normalized or standard accessory connection means of the USB or equivalent type. These known accessories are designed completely separately and independently from the devices with which they are intended to operate. The result is a significant external space requirement and an external appearance that is not in keeping with the electronic device with which it is mainly associated.

It is noted that such accessories include a radio antenna, the operation of which is considerably affected by the means forming a conductive mass in the device, in particular the metal frame of the device, an LCD screen, a printed circuit board. This is why in the known devices the removable accessories of the 3G stick modem, Wifi or equivalent type are situated outside the electronic device. The space requirement of these accessories on the outside of the device is therefore particularly significant and prejudicial: awkward storage and transport, risk of breaking or being torn off.

The purpose of the invention is therefore to overcome all or some of the above drawbacks of the electronic devices by proposing a very compact and integrated device, suitable for receiving an accessory of the 3G modem type, which is also compatible with other devices provided with standard ports.

A second aim of the invention is to reduce the risks of a removable accessory of this type, connected to an electronic device, being torn off.

A third aim of the invention is to optimize the energy requirement of portable electronic devices.

To this end, a subject of the invention is an electronic device arranged to receive a removable remote wireless data transmission accessory, in particular of the “stick modem” type,
said accessory comprising a body of the accessory, at least one radio antenna, accessory connection means linked to the body of the accessory,
said device comprising device connection means, arranged to connect with the removable accessory and to be coupled with the accessory connection means,
characterized in that said device is arranged to receive the removable accessory in a slot, the device being structured so as to allow the radio antenna to transmit data remotely when the accessory body and/or the radio antenna is at least partially inserted in said slot, in an active data transmission position of the accessory.

The removable accessory for example of the “stick modem” type is provided with standard connection means (of the USB, HDMI, SD, MICROSD or equivalent type). It has a general form in which the main body or the assembly constituted by the main body and the coupled antenna is at least partially inserted into the slot of the device. This contrasts with the devices of the prior art, where only the accessory connection means of the removable accessory are inserted into the device connection means.

The removable accessory is inserted into the device in a very compact and integrated manner. The space requirement of the removable accessory is considerably reduced or even zero on the outside of the electronic device. This accessory however remains a wireless data transmission means with standard connectors (USB, HDMI, SD, MICRO SD etc.) that are perfectly compatible with the associated connectors of any other electronic device: PC, tablet, multimedia player or console etc. In the latter case, the connected removable accessory will be used in a more standard fashion outside said other electronic device.

According to further advantageous features of the invention, the radio antenna is clear of (or offset from) conductive elements of the device, such as a frame or a metal surface, an LCD screen or a printed circuit board, when the accessory is in the active data transmission position. These conductive elements thus do not obstruct the transmission of radio data. This also relates to antennas of the “slot” type using conductive elements necessary for their operation, as it is advisable that other adjacent conductive elements of the device do not affect the operation of the antenna.

According to further advantageous features of the invention, the radio antenna is entirely inserted in said slot when the accessory is in the active data transmission position.

According to further advantageous features of the invention, the radio antenna is covered by means that are permeable to radio waves, in particular a fascia of the electronic device made of plastic material, when the accessory is in the active data transmission position. This fascia forms an integral part of the outer case of the device and hides the accessory received in the slot.

According to further advantageous features of the invention, the radio antenna is situated at least partially outside the slot when the removable accessory is in the active data transmission position. The accessory body itself is at least partially inserted in the slot. The portion of the accessory protruding from the electronic device facilitates gripping the accessory by the user.

According to further advantageous features of the invention, the accessory forms a protrusion outside the slot of less than 5 mm. The electronic device can then be used and transported without the special precautions required for standard electronic devices equipped with fully protruding accessories.

According to further advantageous features of the invention, the slot is laterally closed in relation to a longitudinal direction of introduction of the removable accessory into the slot. The case covers the accessory inserted in the slot.

According to further advantageous features of the invention, the slot is open laterally in relation to a longitudinal direction of introduction of the removable accessory into the slot, the lateral opening being arranged in a main face of the device, the removable accessory body visibly filling said opening and flush with an adjacent outer surface of the electronic device, when the accessory is in the active data transmission position. The case of the device forms a recess allowing the accessory inserted in the slot to be seen. This recess is completed by the form of the accessory seen through the recess. This lateral opening of the slot allows an economy of material and makes it possible to reduce the thickness of the device to the minimum necessary, while receiving the accessory and holding it therein.

According to further advantageous features of the invention, the radio antenna is enclosed in a housing of the removable accessory, extending the accessory body opposite to the accessory connection means, the housing filling the lateral opening in a visible manner and being flush with an adjacent outer surface of the electronic device, when the accessory is in the active data transmission position. In this case, the recess formed in the case of the device is completed by the form of the accessory body and the antenna housing, seen through the recess.

According to further advantageous features of the invention, the slot contains an insertion opening through which the accessory is inserted, the removable accessory closing said insertion opening in a manner substantially flush with an adjacent outer surface of the device, when the accessory is in the active data transmission position. The insertion opening is for example situated on the section of the device defining its thickness between two main faces.

According to further advantageous features of the invention, the accessory body has a thickness that is less than or equal to 0.8 centimetres.

According to further advantageous features of the invention, the accessory body comprises electronic components and protection means at least partially covering the electronic components, in particular on one of their faces.

According to further advantageous features of the invention, the device comprises a flap allowing the slot to be closed in a manner substantially flush with an adjacent outer surface of the device when the removable accessory is removed from the device. The slot and the device connection means are thus protected. Due regard is given to the external visual appearance of the device.

According to further advantageous features of the invention, the device connection means are mobile in the slot, in particular rotatably or slidably, between a first retracted position in the slot and a second deployed position towards an opening of the slot or the outside of the device.

According to further advantageous features of the invention, the accessory is in the active data transmission position when the device connection means are arranged in their second position (position beside the insertion opening, i.e. opposite to the base of the slot with respect to the longitudinal direction of insertion of the accessory).

According to further advantageous features of the invention, the accessory is in the active data transmission position when the device connection means are arranged in their first position (position adjacent to the base of the slot).

According to further advantageous features of the invention, the device comprises guide means, in particular guide ways or rails, cooperating with the outer shape of the accessory body, these means providing the guidance of the accessory during its insertion into the slot.

According to further advantageous features of the invention, the device connection means of the “female” type define a passage into which the “male” type accessory connection means are guided, the guidance being obtained by a contact surface of the device connection means which is open on the periphery of the accessory connection means. This open structure of the device connection means allows an economy of material and a reduced space requirement around the accessory connection means. Moreover, the guidance is reduced to a strict minimum providing the contact between the respective contactors of the device connection means and the accessory means. These guide means of the device connection means are not intended to hold the removable accessory assembly, the latter being guided via its accessory body into the slot of the device. The guidance and contact functions are thus advantageously separate. It is noted that the device contains moreover conductive elements (plate, screen etc.) around the connection means, but separate from the latter and from the above-mentioned guide means in order to avoid or limit the electrostatic interference around the contacts of the connection means.

According to further advantageous features of the invention, the connection means of the device and the accessory are chosen from the following standards: USB, HDMI, Firewire, SD, MICRO SD or another equivalent standard.

A subject of the invention is also a casing comprising a fascia structured to receive and protect a removable accessory of an electronic device having all or some of the preceding features.

### DESCRIPTION OF THE FIGURES AND EMBODIMENTS

Other features and advantages of the invention will become apparent on reading the following description of non-limitative embodiments of the invention and in the light of the attached drawings in which:

FIG. 1 shows a partial view of an electronic device according to the invention, equipped with a removable accessory for data transmission of the 3G modem or equivalent type received in a slot of the device,

FIG. 2 shows a partial view of any electronic device (or the electronic device according to the invention) equipped with the removable accessory in FIG. 1, the latter being situated in standard fashion on the outside of the device when it is connected to a port or to standard external device connection means,

FIG. 3 shows diagrammatically a profile view of an electronic device provided with a removable accessory according to a first embodiment of the invention, this profile view being a longitudinal section at the level of the removable accessory,

FIG. 4 shows a partial view in the direction of the arrow F of the electronic device in FIG. 1,

FIG. 5 shows in a similar way to FIG. 3 a profile view of an electronic device provided with a removable accessory according to another embodiment of the invention,

FIG. 6 shows in a similar way to FIG. 3 a profile view of an electronic device provided with a removable accessory according to yet another embodiment of the invention,

FIG. 7 shows in a similar way to FIG. 3 a profile view of an electronic device provided with a removable accessory according to yet another embodiment of the invention,

FIGS. 8 and 9 show an embodiment of an electronic device according to the invention, respectively in a retracted position and a deployed position in relation to the device, the accessory sliding in translation in its slot,

FIGS. 10 to 12 show a further embodiment of an electronic device according to the invention, respectively in a retracted, partially deployed and fully deployed position in relation to the device, the accessory being slidable in translation in its slot and,

FIG. 13 shows a further embodiment of the electronic device according to the invention, in which the accessory is articulated with respect to the electronic device.

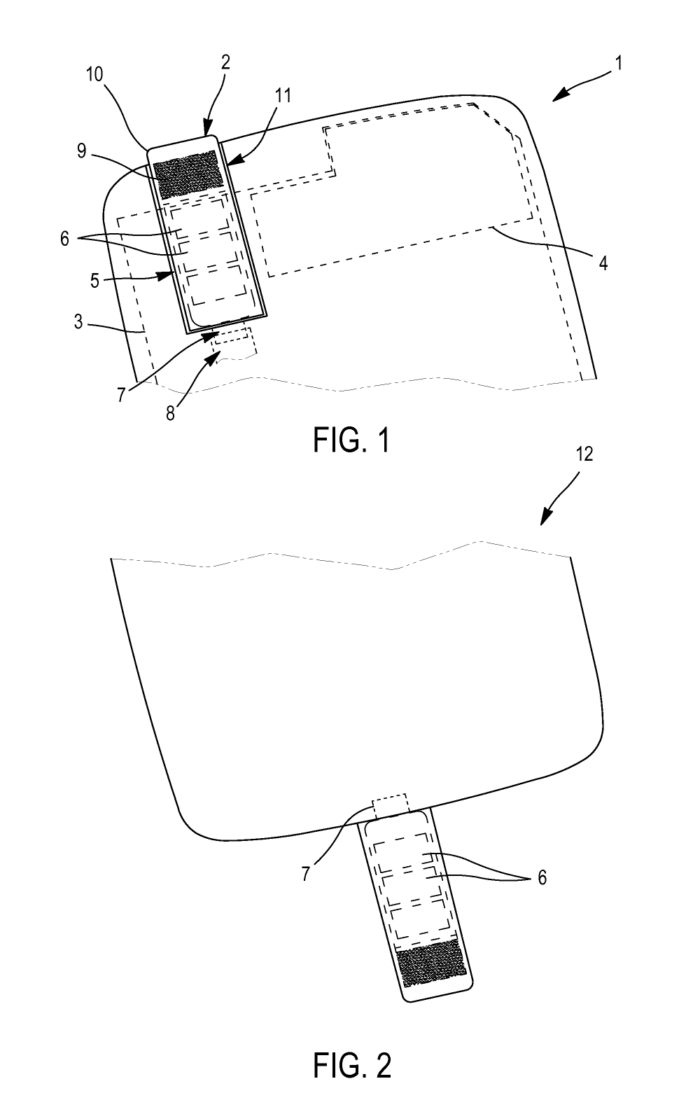

In FIG. 1 a view of an electronic device 1 according to the invention has been shown, typically a tablet or a multimedia player or any other device of the same type that must receive a removable remote wireless data transmission accessory 2. Such a device typically comprises an LCD screen 3, the contour of which is shown in dashes, one or more printed circuit boards 4 (PCB) and other elements not shown in this case for reasons of clarity. The device 1 has a generally flattened shape between two main faces. FIG. 1 therefore shows a flat view of the device 1.

The removable accessory 2 is for example a 3G or Wifi modem or equivalent. Other communications standards or protocols can be envisaged without exceeding the scope of the invention. The accessory 2 is of the “stick” type i.e. it comprises an accessory body 5 enclosing electronic components 6 necessary for the operation of the accessory (for data storage and transmission, possible activation of an LED etc.). The accessory body 5 has a generally elongated shape. Its thickness is preferably less than 0.8 cm. The accessory body 5 also comprises protection means (fascia) at least partially covering the electronic components, in particular on one of their faces. The accessory body 5 supports, at one end, accessory connection means 7 which are intended to be coupled in contact with device connection means 8 provided on the device 1. The accessory 2 also comprises a radio antenna 9 (RF) situated in a housing 10 extending the accessory body 5 at the opposite end to the accessory connection means 7.

According to an essential feature of the invention, the device 1 comprises a slot 11 for receiving at least part of the accessory 2, this part being constituted at the minimum by a portion of the accessory body 5. In the example of FIG. 1, a slot is shown structured to receive the entire accessory body 5 and all or part of the antenna 9. The slot 11 is shaped such that a portion of the accessory body 5 and of the antenna 9 is inserted in the slot 11, while allowing the antenna to operate correctly, i.e. to receive and transmit radio waves. Thus in an active data transmission position of the accessory 2, the accessory body 5 and/or the antenna are at least partially inserted in the slot 11. The accessory 2 has an external shape which, at least in section transverse to the longitudinal direction of introduction in the slot, is complementary to the internal shape of the slot 11.

To this end the antenna 11 is clear, i.e. distanced from the conductive elements of the device that are typically the LCD screen 3, a metal frame or reinforcement of the device, a printed circuit (PCB) etc., while this list of elements capable of forming a conductive mass prejudicial to the radio waves transmitted or received by the antenna 9 is not exhaustive. The antenna is preferably separated by at least 10 mm from the conductive elements. The antenna can be of the order of 10 mm distant from a conductive surface and of the order of 30 mm from a printed circuit.

The accessory connection means 7 are normalized or standard means, of the USB, Firewire, HDMI, SD, MICRO SD type or equivalent. Thus the accessory can be used with the slot 11 structured in a manner specifically compatible with the accessory. Alternatively, the accessory provided with standard connection means 7 can be used with another external port of the electronic device itself (port having adapted device connection means) or an external port of another device 12 (FIG. 2), for example a PC, another tablet or another multimedia player etc.

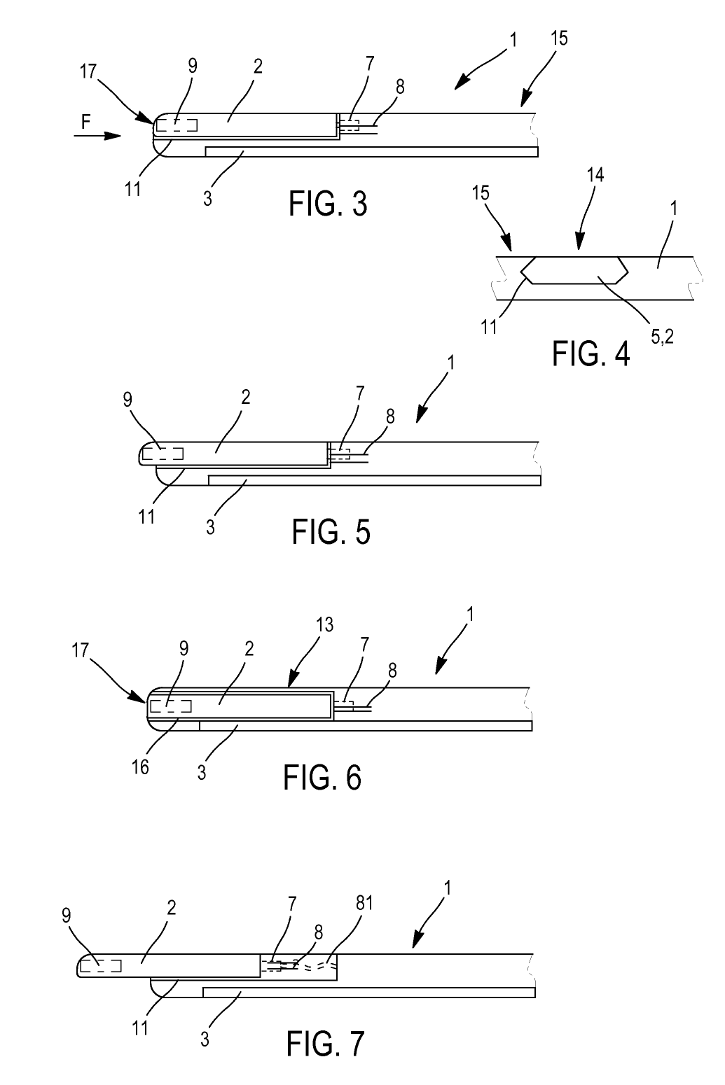

The radio antenna 9 can be entirely inserted in the slot 11 (FIGS. 1 and 3) when the accessory is in its active data transmission position. Alternatively, it can also be partially inserted (FIG. 5), i.e. have a portion protruding outside the slot 11 when the removable accessory is in the active data transmission position. In this case, the accessory 2 forms a protrusion outside the slot 11 preferably less than 5 mm. The essential criterion remains that the antenna is situated so as not to conflict with conductive elements of the device, despite of an at least partial insertion of the accessory 2 in the slot 11 in order to limit its external space requirement.

By “conductive elements”, is meant here conductive means that are not useful to the operation of the antenna itself; in fact particular antennas (“slot” type) require conductive elements that are not included in the conductive elements mentioned above which are prejudicial to the data transmission.

When the radio antenna 9 is partially or fully inserted in the slot 11, it can be covered, in addition to its protective housing 10, by means that are permeable to radio waves, for example a fascia 13 made of plastic material of the electronic device 1. This fascia forms an integral part of the case or of the outer skin of the device 1 (FIG. 6).

According to an aspect of the invention shown in FIGS. 1, 3 and 4, the slot 11 is laterally open in relation to a longitudinal direction of insertion of the removable accessory 2 in the slot 11. The lateral opening 14 is arranged in a main face of the device 1. The accessory body 5 fills (or covers) the opening 14 in a manner that is visible and flush with an adjacent outer surface 15 of the electronic device 1, when the accessory 2 is in the active data transmission position. The housing 10 of the antenna 9 can also fill (or cover) the lateral opening 14 when the antenna 9 is entirely inserted in the slot 11 as shown in FIG. 3. In another configuration, the antenna can protrude fully or partially outside the slot 11 as shown for example in FIG. 5.

With reference to FIG. 6, an embodiment is shown in which the slot 16 is laterally closed in relation to a longitudinal direction of insertion of the removable accessory 2 in the slot. This closure is provided in particular by the fascia 13 of the case or of the outer skin of the device. The accessory 2 in active data transmission position is thus surrounded or framed on its periphery by the form of the device 1.

FIGS. 3 and 6 show that slot 11, 16 has an insertion opening 17 through which the accessory 2 is inserted. In active data transmission position, the end of the accessory adjacent to the antenna can be structured to close the insertion opening 17 in a manner substantially flush with an adjacent outer surface of the device 1.

The device can include a flap (flexible or rigid, not shown) allowing the slot 11, 16 to be closed in a manner substantially flush with an adjacent outer surface of the device when the removable accessory is withdrawn from the device. This flap can be provided to close a lateral opening 14 of the slot (case shown in FIGS. 3, 4 and 6) and/or the insertion opening 17 of the slot. The flap can be folded away and is in all cases connected securely to the device.

FIG. 7 shows that the device connection means 8 are mobile in the slot 11 or 16 between a first retracted position in the slot and a second deployed position towards the insertion opening 17. The movement can take place by translation/sliding (shown in FIG. 7) or by rotation of the device connection means 8 with respect to the slot. Flexible conductors 81 link the device connection means 8 to the electronics of the device 1.

This sliding of the device connection means 8 allows the accessory to be moved in the slot between a position that is also retracted and a deployed position. It can be provided that the accessory 2 is placed in the active data transmission position when the device connection means 8 are in the deployed position. In this case the accessory is inactivated when the device connection means 8 are in their retracted position. Conversely, it can be provided that the accessory is arranged in the active and passive position when the device connection means are respectively in their retracted and deployed position. The inactivation can be carried out for the purposes of saving energy.
Whatever embodiment is chosen involving a movement in translation of the accessory 2 in the slot 11, 16, the device 1 comprises guide means cooperating with the outer shape of the accessory body 5 and/or the antenna housing. These guide means are typically a system of guide ways or lateral rails situated inside the slot. FIG. 4 shows a non-limitative example of guide means in which the accessory 2 has lateral edges (or lateral bosses or any suitable protruding shape) penetrating into corresponding concave shapes inside the slot 11. The accessory is thus perfectly integrated, guided and held in the device 1.

To reduce even further the space requirement of the device or reduce the material, the device connection means 8 of the “female” type define a passage in which the accessory connection means 7 of the “male” type are guided, the guiding being obtained by a contact surface of the device connection means 8 which is open at the periphery of the accessory connection means 7. Typically in the case of device connection means 8 of the USB type, only the contactors and their support come into contact with the associated contactors of the accessory connection means 7. A (conventional) metal cage, closed at the periphery of the accessory connection means 7 which conventionally has the function of guiding the connection means, holding the accessory and anti-electrostatic interference screen, is dispensed with. A conductive element or a screen separate from the device connection means can be provided in the structure of the device itself in order to compensate for the absence of a metal cage around the device connection means 8.

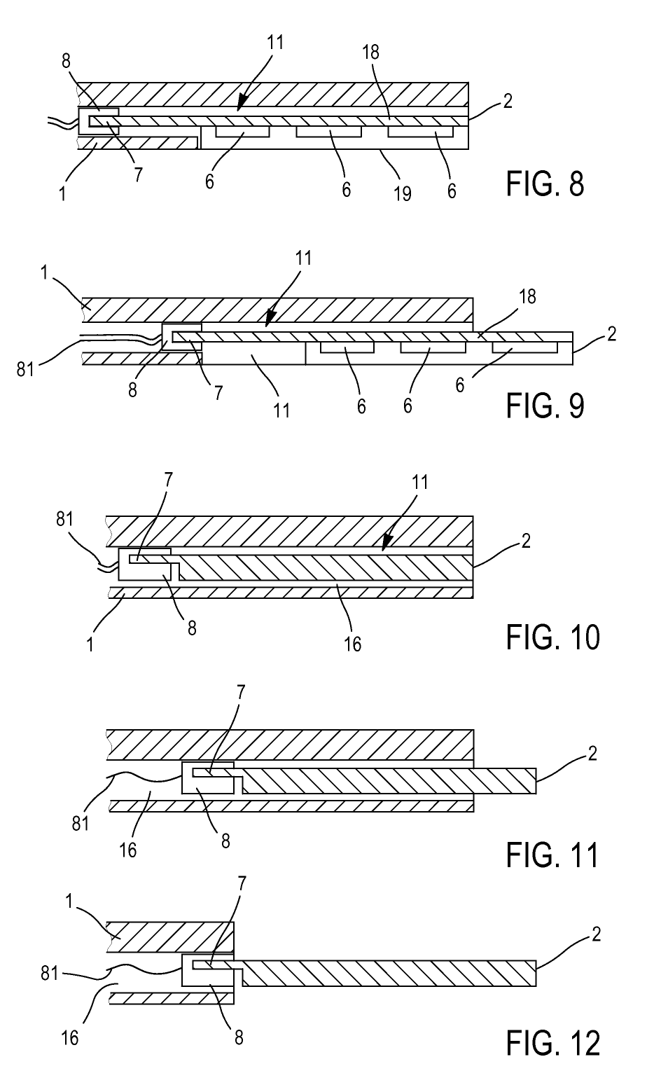

As shown in the embodiment of FIG. 8, the accessory 2 comprises a printed circuit 18 bearing electronic components 6 on at least one of the faces of the printed circuit. The electronic components are preferably protected by protection means 19, in particular protecting the electronic components from impacts and/or electromagnetism and/or water splashes. The protection means 19 are integral with the printed circuit 18, being secured for example by bonding.

In the embodiment of FIG. 8, only one face of the printed circuit 18 is equipped with electronic components 6, in order to minimize a thickness of the accessory, the other face being provided with a protection 19.

Preferably the protection means 19 constitute a part of the surface of the electronic device in order to reduce the thickness of the electronic device equipped with the accessory.

FIGS. 8 and 9 respectively show the retracted and deployed positions of the accessory 2, one or other of its positions being able to be chosen for the activation of the accessory 2.
FIGS. 10 to 12 show yet a further embodiment of the device. The accessory 2 is mobile in the slot 16 between a position fully integrated/inserted in the slot 11 (FIG. 10), a partially deployed position (FIG. 11) in which the accessory partially protrudes outside the slot, and a fully deployed position outside the slot 16 (FIG. 12). One or other of these positions can be chosen for the activation of the accessory, the latter being inactivated in the other positions. It is noted that in the case of FIG. 12, where the device connection means 8 are arranged at the opening of the slot 16, they become accessible to any other removable accessory having compatible connection means.

Changing between the retracted position and the partially deployed position can typically be carried out by a system known as the “push/pull” type. Axial pressure on the end of the accessory makes it possible to insert it to a position where it is then automatically pushed back into the partially deployed position, via return means, not shown. The return to the retracted position is carried out in a similar way with the accessory being inserted to a position beyond the retracted position, then returning automatically to its retracted position.

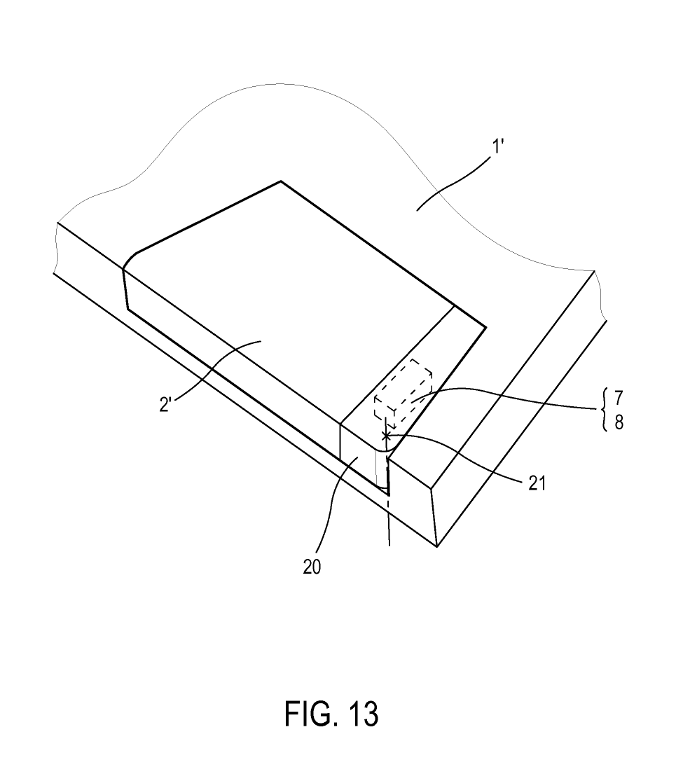

FIG. 13 shows a further embodiment of the invention in which the accessory 2′ is connected to the device connection means 8, the latter being mounted on a support 20 that is mobile in rotation with respect to the device 1′ and to the slot for receiving the accessory, about an axis of articulation 21.

The invention also provides a cover. This cover comprises a protective fascia of an accessory of an electronic device 1 when said accessory is removed from an electronic device. In an embodiment of the invention that is not shown, the cover can comprise a slot for receiving the accessory. In a further embodiment that is not shown, the cover comprises rotation means and/or sliding means similar to those described in relation to the device 1. The rotation means and/or sliding means are adapted for a partial or total insertion of the accessory into the fascia. For example only the accessory connection means 7 protrude from the cover.

Of course, the invention is not limited to the examples and embodiments described above. It comprises all technical equivalents of the means described.

1. Electronic device (1, 1′) arranged to receive a removable remote wireless data transmission accessory (2, 2′), in particular of the 3G “stick modem” or Wifi type,
said accessory (2, 2′) comprising an accessory body (5), at least one radio antenna (9), accessory connection means (7) linked to the accessory body (5),
said device (1) comprising device connection means (8), arranged to connect with the removable accessory (2, 2′) and to be coupled with the accessory connection means (7),
characterized in that said device (1, 1′) is arranged to receive the removable accessory (2, 2′) in a slot (11, 16), the device being structured so as to allow the radio antenna (9) to transmit data remotely when the accessory body (5) and/or the radio antenna (9) is at least partially inserted in said slot (11, 16), in an active data transmission position of the accessory (2, 2′).

2. Electronic device (1, 1′) according to claim 1, characterized in that the radio antenna (9) is clear of conductive elements (3, 4) of the device, such as a frame or a metal surface, an LCD screen (3) or a printed circuit board (4), when the accessory (2, 2′) is in the active data transmission position.

3. Electronic device according to claim 2, characterized in that the radio antenna (9) is fully inserted in said slot (11, 16) when the accessory (2, 2′) is in the active data transmission position.

4. Electronic device according to claim 1, characterized in that the radio antenna (9) is covered by means (13) that are permeable to radio waves, in particular a fascia made of plastic material of the electronic device (1, 1′) when the accessory (2, 2′) is in the active data transmission position.

5. Electronic device according to claim 1, characterized in that the radio antenna (9) is situated at least partially outside the slot (11, 16) when the removable accessory (2, 2′) is in the active data transmission position.

6. Electronic device according to claim 5, characterized in that the accessory (2, 2′) forms a protrusion outside the slot (11, 16) of less than 5 mm.

7. Electronic device according to claim 1, characterized in that the slot (16) is laterally closed in relation to a longitudinal direction of introduction of the removable accessory (2, 2′) into the slot.

8. Electronic device according to claim 1, characterized in that the slot (11) is laterally open in relation to a longitudinal direction of introduction of the removable accessory (2, 2′) into the slot, the lateral opening (14) being arranged in a main face of the device (1, 1′), the accessory body (5) visibly filling said opening and flush with an adjacent outer surface (15) of the electronic device, when the accessory (2, 2′) is in the active data transmission position.

9. Electronic device according to claim 8, characterized in that the radio antenna (9) is enclosed in a housing (10) of the removable accessory (2, 2′), extending the accessory body (5) opposite to the accessory connection means (7), the housing visibly filling the lateral opening (14) and flush with an adjacent outer surface (15) of the electronic device, when the accessory (2, 2′) is in the active data transmission position.

10. Electronic device according to claim 1, characterized in that the slot (11, 16) includes an insertion opening (17) through which the accessory (2) is introduced, the removable accessory (2) closing said insertion opening (17) in a manner that is substantially flush with an adjacent outer surface of the device, when the accessory (2) is in the active data transmission position.

11. Electronic device according to claim 1, characterized in that the accessory body (5) has a thickness less than or equal to 0.8 centimetres.

12. Electronic device according to claim 1, characterized in that the accessory body (5) comprises electronic components (6) and protection means (19) at least partially covering the electronic components (6), in particular on one of their faces.

13. Electronic device according to claim 1, characterized in that it comprises a flap allowing the slot (11, 16) to be closed in a manner that is substantially flush with an adjacent outer surface (15) of the device when the removable accessory (2, 2′) is removed from the device.

14. Electronic device according to claim 1, characterized in that the device connection means (8) are mobile in the slot (11, 16), in particular rotatably or slidably, between a first retracted position in the slot (11, 16) and a second deployed position towards an opening (17) of the slot or outside of the device (1, 1′).

15. Electronic device according to claim 14, characterized in that the accessory (2, 2′) is in the active data transmission position when the device connection means (8) are arranged in their second position.

16. Electronic device according to claim 14, characterized in that the accessory (2, 2′) is in the active data transmission position when the device connection means (8) are arranged in their first position.

17. Electronic device according to claim 1, characterized in that it comprises guide means cooperating with the outer shape of the accessory body (5) providing the guiding of the accessory (2, 2′) during its introduction into the slot (11, 16).

18. Electronic device according to claim 1, characterized in that the device connection means (8) of the “female” type define a passage in which the accessory connection means (7) of the “male” type are guided, the guiding being obtained by a contact surface of the device connection means (8) which is open at the periphery of the accessory connection means (7).

19. Electronic device according to claim 1, characterized in that the connection means (8) of the device and of the accessory are chosen from the following standards: USB, Firewire, HDMI, SD, MICRO SD or another equivalent standard.

20. Electronic device according to claim 2, characterized in that the radio antenna (9) is fully inserted in said slot (11, 16) when the accessory (2, 2′) is in the active data transmission position.
